(19) United States
(12) Patent Application Publication
(10) Pub. No.: US 2009/0270521 A1
(43) Pub. Date: Oct. 29, 2009

(54) METHOD FOR MANUFACTURING A FIRE RESISTANT FOAM

(75) Inventor: MONIQUE MARAF, Haasdonk (BE)

Correspondence Address: Mark A. Koch;Professional Corporation, 583 Main Street East, Hamilton, ON, L8M 1J4, CA

(73) Assignee: 1573132 ONTARIO LIMITED, Burlington (CA)

(21) Appl. No.: 12/429,228

(22) Filed: Apr. 24, 2009

(30) Foreign Application Priority Data
Apr. 29, 2008 (BE) 2008/0249

(51) Int. Cl. C08G 18/32

(52) U.S. Cl. 521/122; 521/170

(57) ABSTRACT

A method for the manufacture of a fire resistant foam, which includes mixing together the ingredients of a polyol, a di-isocyanate and a sodium silicate, wherein the sodium silicate is heated to liquefy it enough to facilitate mixing it with the polyol and the di-isocyanate. A fire resistant foam, which includes a foam manufactured in accordance with the above mentioned method.

This application claims convention priority from previously filed Application No.: 2008/0249 filed Apr. 29, 2008 by Monique Maraf under the title Method for Manufacturing a Fire Resistant Foam in the country of Belgium.

### FIELD OF THE INVENTION

This invention relates to a method for manufacturing a fire resistant foam.

### SUMMARY OF THE INVENTION

It is common knowledge that a foam, like PU foam (polyurethane foam) is built up from a copolymer with a hard and soft segment, such as a di-isocyanate and a polyol respectively.

To manufacture a PU foam, the polyol and di-isocyanate are mixed with each other using a standard method, whereby the choice of the segments shall have an influence on the ultimate properties of the manufactured foam.

Foams of this type are not fire retardant or fire-resistant and in the event of a fire they cause significant smoke formation with dissipation of toxic gasses.

The purpose of this invention is to provide a solution for one or more of the aforementioned disadvantages and/or other disadvantages, as it provides a method for the manufacture of a fire resistant foam, whereby a polyol and a di-isocyanate are mixed together, and whereby sodium silicate is also added in addition to the aforementioned ingredients, after this sodium silicate has been heated enough to liquefy it, therefore facilitating mixing it with the polyol and the di-isocyanate.

By liquefying the sodium silicate, this product can be mixed with the aforementioned basic ingredients to form a foam.

An advantage is that, through the addition of sodium silicate, the foam becomes exceptionally fire retardant and fire resistant and little combustion gasses are released in the event of a fire.

In line with a preferred characteristic, up to 5 times more sodium silicate is added by weight to the total quantity of polyol and di-isocyanate, which generates exceptionally good, results in regard to improving the fire resistance of the foam.

In line with a preferred characteristic of the invention, the method also contains the additional step of adding graphite to the mixture.

The advantage of graphite additions is that, in the event of fire, the graphite forms a crust on the foam and in so doing brings about an additional fire retardant effect.

Graphite can be very resistant to extremely high temperatures.

This invention also relates to a fire retardant foam, whereby the foam is manufactured based on a mixture of a polyol with a di-isocyanate, and liquid sodium silicate.

The use of the aforementioned foam composition results in some of the advantages described in the foregoing.

### BRIEF DESCRIPTION OF THE DRAWINGS

With the intention of providing an improved demonstration of the characteristics of the invention, an example is given below, without any restrictive character whatsoever, with reference to the corresponding figures, of a preferred embodiment for the manufacture of a fire resistant foam in accordance with the invention, in which:

FIG. 1 schematically represents a system for the application of a method according to the invention;

FIG. 2 schematically represents a variant of the system for the application of a method according to the invention;

### DESCRIPTION OF THE PREFERRED EMBODIMENTS

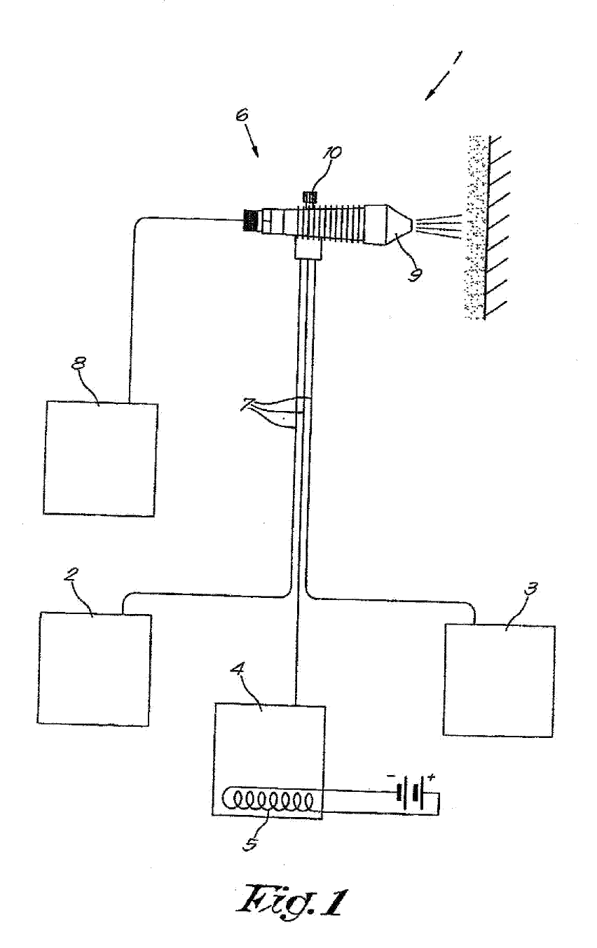

The system shown in FIG. 1 for spraying a foam, for example around the frames of windows or doors, mainly comprises three reservoirs numbered with reference numerals 2, 3 and 4 in which the basic ingredients are stored, in particular reservoir for example reservoir 2 for polyol; reservoir 3 for di-isocyanate and reservoir 4 for sodium silicate.

The sodium silicate, reservoir used for supply initially has a thick, viscous consistency at room temperature, and preferably a solid substance percentage between 48% and 60%, and preferably a solid substance percentage of 53.5%.

The reservoir 4 for sodium silicate is also fitted with a heating element 5, which facilitates heating the sodium silicate in such a way that it liquefies and can be mixed with the polyol and the di-isocyanate.

The system 1 is also fitted with a spraying device 6, for example in the form of a spray gun, which is connected using hoses 7 to each of the aforementioned reservoirs 2-4, and also is connected to a source of compressed air 8 in the standard manner.

The spray gun 6 is fitted with a mixing and spray head 9 and control 10 which facilitates selectively combining and mixing the three aforementioned ingredients polyol, di-isocyanate and sodium silicate in the desired quantities in propellant form.

The method that is used according to the invention for the manufacture of a fire resistant foam is as follows.

Prior to mixing the sodium silicate with the aforementioned ingredients, in the method according to the preferred embodiments the sodium silicate is heated, in such a way that it transforms from a thick, syrupy phase into a more liquid phase.

In line with a preferred characteristic of the invention, the sodium silicate is heated to a temperature between 25° C. and 50° C., and preferably between 35° C. and 45° C., which causes the sodium silicate to liquefy enough to be able to mix it together with the abovementioned ingredients in spray gun 6.

The three aforementioned ingredients polyol, di-isocyanate and sodium silicate can each be supplied individually to the control 10 and mixing and spray head 9, as shown in the system in FIG. 1. Mixing of the three ingredients occurs in the spray gun 6.

When the sodium silicate has reached the desired temperature, the three ingredients must be sprayed together in suitable quantities, in such a way that the mixture of these ingredients results in the formation of a foam which is based on a polyol, a di-isocyanate and sodium silicate, which also possesses -fire resistant properties.

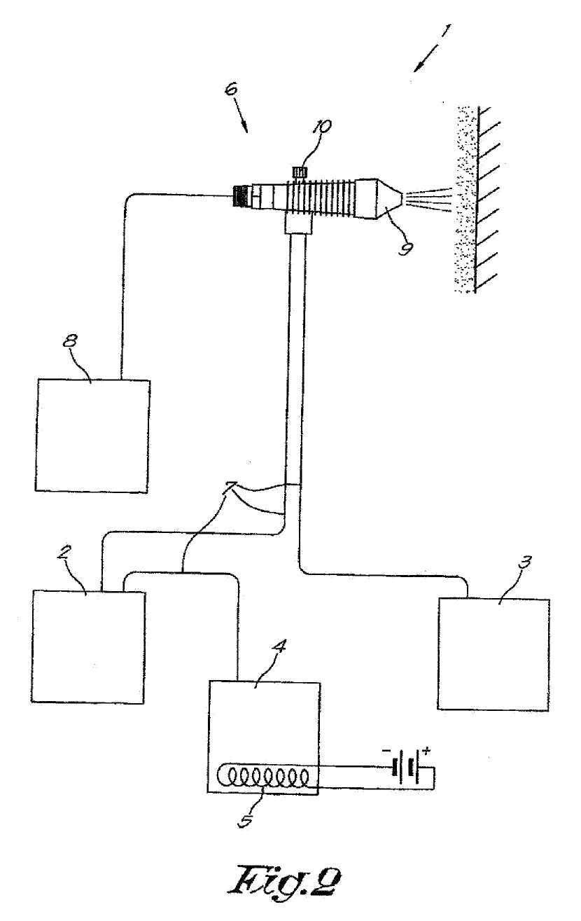

The liquid sodium silicate can also be premixed with the polyol in advance, prior to delivery to spray gun 6. This is shown schematically in FIG. 2, after which, this polyol-sodium silicate mixture and the di-isocyanate are each individually supplied to the control 10 and mixing and spray head 9.

In an alternative embodiment of the method, the d-isocyanate can be premixed with the sodium silicate, after which this di-isocyanate/sodium silicate mixture and the polyol are each individually supplied to the control 10 and spraying head 9.

In the method for the manufacture of a foam, the polyol and the di-isocyanate can be mixed in a weight ratio between 1/1 and 1/1.5 respectively.

The preferred quantity of sodium silicate is at least 100 grams per kilogram polyol and di-isocyanate together, but the greater the quantity of sodium silicate, the greater the fire resistant properties of the foam. Applying the method according to the preferred embodiments, up to 5 kilograms of sodium silicate can be added per kilogram polyol and di-isocyanate together resulting in the manufacture of foam with a density between 80 and 500 kg/m3. Conventional compositions and methods in the prior art result in densities up to 40 or 50 kg/m3.

Subject to the application and the desired fire retardant properties, a suitable mixture will is selected to be used.

In a practice, a larger quantity of sodium silicate can be added, for example 2 kilograms per kilogram of polyol and di-isocyanate.

In a preferred embodiment of the method, additional graphite can also be added.

It is self-evident that the ratios and quantities of ingredients in the mixtures defined in the foregoing are merely for illustrative purposes and this invention is by no means restricted to these.

This invention is by no means restricted to the method described by way of example only, or a method for the manufacture of fire-resistant foam and a foam according to the invention can be achieved according to numerous variants without exceeding the scope of the invention.

I claim:

1. A method for the manufacture of a fire resistant foam comprising mixing together the ingredients of a polyol, a di-isocyanate and a sodium silicates wherein the sodium silicate is heated to liquefy it enough to facilitate mixing it with the polyol and the di-isocyanate.

2. The method according to claim 1, wherein the sodium silicate is heated to a temperature between 25° C. and 50° C. prior to mixing with the polyol, and the di-isocyanate.

3. The method according to claim 1, wherein the sodium silicate is heated to a temperature between 35° C. and 45° C. prior to mixing with the polyol, and the di-isocyanate.

4. The method according to claim 1 including delivery of the ingredients to a mixing and spray head to mix the three ingredients together under pressure to form a propellant.

5. The method according to claim 4 including delivery of compressed air to the mixing and spray head.

6. The method according to claim 4, including delivery of each of the three aforementioned ingredients individually to the mixing and spray head.

7. The method according to one of the claims 3 including premixing of the sodium silicate with the polyol or the di-isocyanate after which the premixed product and the residual product are each individually supplied to a mixing and spray head.

8. The method according to claim 1 including mixing the polyol and the di-isocyanate in a ratio selected to be between 1/1 and 1/1.5 by weight respectively.

9. The method according to claim 1 including mixing a quantity of sodium silicate which is greater than 100 grams per kilogram of polyol and di-isocyanate combined.

10. The method according to claim 1 including mixing a quantity of sodium silicate which is less than 10 kilograms per kilogram of polyol and di-isocyanate combined.

11. The method according to claim 1, including mixing a quantity sodium silicate which is at least 3 kilograms and less than 5 kilograms per kilogram polyol and di-isocyanate combined.

12. The method according to claim 1, including adding graphite to the mixture of polyol and di-isocyanate and sodium silicate.

13. A fire resistant foam, comprising a foam manufactured in accordance with the method of claim 1.

14. The fire resistant foam according to claim 13, wherein the quantity of sodium silicate added is selected such that a foam is formed having a density of between 80 and 500 kg/m3.

15. The fire resistant foam according to claim 13, wherein the quantity of sodium silicate added is selected such that a foam is formed having a density between 300 and 500 kg/m3.

16. The fire resistant foam according to claim 13, wherein the ratio of polyol and di-isocyanate respectively is selected to be between 1/1 and 1/1.5 by weight.

17. The fire resistant foam according to claim 13, wherein the quantity of sodium silicate is greater than 100 grams per kilogram of polyol and di-isocyanate combined.

18. The fire resistant foam according to claim 13, wherein the quantity of sodium silicate is less than 10 kilograms per kilogram of polyol and di-isocyanate combined.

19. The fire resistant foam according to claim 13, wherein graphite is added to the mixture of polyol and di-isocyanate and sodium silicate.

20. A fire resistant foam, consisting of a mixture of polyol with di-isocyanate, and liquid sodium silicate, wherein the sodium silicate is heated to liquefy it enough to facilitate mixing it with the polyol and the di-isocyanate.
